(19) United States
(12) Patent Application Publication
(10) Pub. No.: US 2010/0165069 A1
(43) Pub. Date: Jul. 1, 2010

(54) IMAGE CODEC APPARATUS

(76) Inventor: Shinya Kadono, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/294,678

(22) PCT Filed: Mar. 13, 2007
(86) PCT No.: PCT/JP2007/054917

§ 371 Date: Sep. 26, 2008

(30) Foreign Application Priority Data
Mar. 29, 2006 (JP) 2006-090790

(51) Int. Cl. H04N 7/14

(52) U.S. Cl. 348/14.01; 375/E07.027

(57) ABSTRACT

Provided is an image codec apparatus that allows a user to check his own-image properly while feeling a strong sense of presence. The image codec apparatus (100) includes cameras (Ca, Cb, and Cc) that generate taken-image data by shooting, monitors (Ma, Mb, and Mc) that display images, encoders (101, 102, and 103) that code taken-image data, decoders (121, 122, and 123) that decodes coded image data for generating decoded image data, and synthesizers (111, 112, and 113) that process the taken-image data generated by the cameras (Ca, Cb, and Cc) for generating processed image data and synthesizing a processed image represented by the processed image with the decoded image and output, to the monitors (Ma, Mb, and Mc), synthesized image data that represents synthesized image.

### TECHNICAL FIELD

The present invention relates to an image codec apparatus for use in, for example, a video conference system and a videophone system including cameras and monitors.

### BACKGROUND ART

Recently, with the advent of the multimedia age, where audio, images, and other pixel values are handled integrally, conventional information media, in other words, means through which information is conveyed to people, such as newspapers, magazines, TVs, radios, and telephones, have come to be included in multimedia. Generally, multimedia refers to representation associated not only with characters but also with graphics and audio, and more particularly with images or the like. In order to include the above-mentioned conventional information media in multimedia, representing such information in digital format is a prerequisite.

Calculating the amount of information included in each of the above-mentioned information media in the amount of digital data shows that textual information requires 1 to 2 bytes per character, whereas audio information requires more than 64 Kbits per second (for audio quality for telephone communication), and moving images require more than 100 Mbits (for image quality for current television reception) per second. Therefore, in the above-mentioned information media, it is not practical to handle such a large amount of data in digital format without processing. For example, videophones have already been put into practical use via the Integrated Services Digital Network (ISDN) with a transmission rate of 64 Kbit/s to 1.5 Mbit/s. However, videophones cannot transmit images displayed on TV and/or taken with cameras as they are via the ISDN.

Thus, data compression technologies become necessary. For example, videophones employ moving image compression technologies compliant with H.261 and H.263 standards recommended by the International Telecommunication Union-Telecommunication Standardization Sector (ITU-T). For another example, with the data compression technology of the MPEG-1 standard, image data can be stored in ordinary music compact discs (CDs) along with audio data.

Here, the Moving Picture Experts Group (MPEG) is an international standard standardized by the International Organization for Standardization/International Electrotechnical Commission (ISO/IEC) for compressing moving image signals. MPEG-1 is a standard for compressing moving image signals to 1.5 Mbit/s, in other words, compressing data of TV signals to approximately one-hundredth of its original size. The MPEG-1 standard has been intended for an intermediate quality to realize primarily at a transmission rate of about 1.5 Mbit/s. Therefore, MPEG-2 standardized to meet requirements for higher-quality image achieves an image quality for TV broadcast by transmitting moving image signals at a rate of 2 to 15 Mbit/s. The working group (ISO/IEC JTC1/SC29/WG11) in charge of the standardization of the MPEG-1 and the MPEG-2 has now standardized MPEG-4 that achieves a compression rate beyond the rates of the MPEG-1 and the MPEG-2. Further, the MPEG-4 permits coding/decoding and operations on an object basis and realizes new functions necessary for the era of multimedia.

Initially, development of MPEG-4 was aimed at standardizing a low-bit-rate coding method. However, its scope has currently been expanded to be a more versatile coding standard to cover a high-bit-rate coding method including coding of interlaced images. Furthermore, the ISO/IEC and the ITU-T have now jointly standardized MPEG-4 AVC and ITU H.264 as image coding methods using a higher compression rate.

Meanwhile, for networking, high-speed network environments using ADSL and optical fibers have become widespread. This makes data transmission and reception at a bit rate over several Mbit/s available to ordinary households. In the next several years, the available data transmission and reception rate is expected to reach a few tens Mbit/s. Further, it is forecasted that use of the above-mentioned image coding technologies will promote introduction of videophones and video conference systems having image quality for TV broadcast or high definition television (HDTV) broadcast not only to companies that use dedicated lines but also to ordinary households.

Here, the conventional image codec apparatuses using the image coding technologies are described in detail below. Such conventional image codec apparatuses have been used for video conference systems (for example, see Patent Reference 1).

FIG. 1 shows an example of the conventional video conference system. The example shown in FIG. 1 illustrates use of a video conference system by two persons, where each site has a one-panel monitor. This case shows the most typical video conferences and videophones that are currently in use. Here, a system at each site included in the video conference system is configured as an image codec apparatus.

A monitor Ma and a camera Ca are installed in front of a person Pa, and a monitor Md and a camera Cd are installed in front of a person Pd. An output terminal of the camera Ca is connected to the monitor Md, so that an image Pa′ of the person Pa taken with the camera Ca is displayed on the monitor Md. An output terminal of the camera Cd is connected to the monitor Ma, so that an image Pd′ of the person Pd taken with the camera Cd is displayed on the monitor Ma.

The images taken with the cameras are basically coded by encoders and transmitted to decoders. The transmitted images are then decoded by the decoders and displayed on the monitors. FIG. 1 does not include encoders or decoders because they are not essential components for describing which monitor displays the image taken with each camera.

FIG. 2 shows another application example of the conventional video conference system. Specifically, this application example illustrates use of a video conference system by six persons, where each site has a one-panel monitor.

A monitor Ma and a camera Ca are installed in front of the persons Pa, Pb, and Pc, and a monitor Md and a camera Cd are installed in front of persons Pd, Pe, and Pf. An output terminal of the camera Ca is connected to the monitor Md, so that images Pa′, Pb′, and Pc′ of the persons Pa, Pb, and Pc taken with the camera Ca are displayed on the monitor Md. An output terminal of the camera Cd is connected to the monitor Ma, so that images Pd′, Pe′, and Pf′ of the persons Pd, Pe, and Pf taken with the camera Cd are displayed on the monitor Ma.

FIGS. 3A and 3B show examples of own-images displayed in the video conference system described above.

An own-image serves a user for checking his image taken with a camera, and is often used for checking an image transmitted to a counterpart of the user. The user check his own-image to know whether he is shot to be displayed in the middle of a monitor of the counterpart, where he is positioned in the monitor of the counterpart, and how the proportion (size) of his own-image to the monitor of the counterpart is.

FIG. 3A shows an application example of the video conference system in FIG. 1, where an image Pa′ of the person Pa is displayed in an own-image frame Ma′ on the monitor Ma. The image in the own-image frame Ma′ is an own-image. FIG. 3B shows an application example of the video conference system in FIG. 2, where images Pa′, Pb′, and Pc′ of the persons Pa, Pb, and Pc are displayed in the own-image frame Ma′ on the monitor Ma. Thus, video conference systems with a one-panel monitor installed at each site includes a single camera for each site, and images taken with the cameras are simply displayed as own-images on the monitors.

FIGS. 4A to 4C show another conventional video conference system and images displayed in the system.

The video conference system shown in FIG. 4A includes three mutually connected sites each of which has one camera and a plurality of monitors. Monitors Ma1, Ma2, and a camera Ca0 are installed in front of a person Pa. Monitors Mb1, Mb2, and a camera Cb0 are installed in front of a person Pb. Monitors Mc1, Mc2, and a camera Cc0 are installed in front of a person Pc. Here, a system at each site included in the video conference system is configured as an image codec apparatus.

An output terminal of the camera Ca0 is connected to the monitors Mb2 and Mc1, so that an image Pa′ of the person Pa taken with the camera Ca0 is displayed, as shown in FIG. 4B, on the monitors Mb2 and Mc1. An output terminal of the camera Cb0 is connected to the monitors Ma1 and Mc2, so that an image Pb′ of the person Pb taken with the camera Cb0 is displayed on the monitors Ma1 and Mc2. Similarly, an output terminal of the camera Cc0 is connected to the monitors Ma2 and Mb1, so that an image Pc′ of the person Pc taken with the camera Cc0 is displayed on the monitors Ma2 and Mb1.

Thus, as shown in FIG. 4C, the person Pa can view the image Pb′ of the person Pb displayed on the monitor Ma1 and the image Pc′ of the person Pc displayed on the monitor Ma2. Similarly, the person Pb can view the image Pc′ of the person Pc displayed on the monitor Pa and the image Pa′ of the person Pa displayed on the monitor Mb2. The person Pc can view the image Pa′ of the person Pa displayed on the monitor Mc1 and the image Pb′ of the person Pb displayed on the monitor Mc2.

FIG. 5 shows an example of an own-image displayed by the other conventional video conference system described above, that is, the video conference system shown in FIG. 4A. Each site in the other conventional video conference system has one camera; thus, an own-image including an image of a person taken with the camera is displayed. For example, an image taken with the camera Ca0 is displayed as an own-image in an own-image frame Ma1′ on the monitor Ma1, so that the person Pa can check an image Pa′ displayed in the own-image frame Ma1′ on the monitor Ma1.

Meanwhile, there have been suggested video conference systems that enable a user to feel a strong sense of presence by installing a plurality of cameras at each site (for example, see Patent Reference 1).

The video conference system disclosed in Patent Reference 1 includes not a single camera but a plurality of cameras for each site, allowing wider-area shooting and/or multi-angle shooting to enable a user to feel the strong sense of presence as if his counterpart were at the same site as the user is. The user can obtain such strong sense of presence, for example, by having eye contact with his counterpart.

### Patent Reference 1: Japanese Unexamined Patent Application Publication No. 2000-217091

### DISCLOSURE OF INVENTION

### Problems that Invention is to Solve

However, the conventional image codec apparatuses have a problem in convenience that they do not allow users to check their own-images properly while feeling the strong sense of presence.

The present invention, conceived to address this problem, has an object of providing an image codec apparatus that allows users to check their own-images properly while feeling the strong sense of presence.

### Means to Solve the Problems

In order to achieve the above-mentioned object, the image codec according to the present invention is an image codec apparatus for coding and decoding data that represents an image, and the image codec apparatus includes: a plurality of shooting units configured to take images so as to generate taken-image data that represents the taken-images respectively; an image displaying unit configured to obtain image display data that represents an image and to display the image represented by the image display data; a coding unit configured to code sets of the taken-image data generated by the plurality of shooting units; a decoding unit configured to obtain coded image data and to decode the coded image data for generating decoded image data; an image processing unit configured to execute image processing on the sets of the taken-image data for generating processed image data; and an image synthesizing unit configured to synthesize a processed image represented by the processed image data with a decoded image represented by the decoded image data, and to output, as the image display data, synthesized image data that represents a synthesized image.

For example, at a site of a video conference system that includes the image codec apparatus according to the present invention for each site, a plurality of cameras, which is the plurality of shooting units, shoots persons. Meanwhile, a plurality of images taken thereby (own-images) is synthesized with an image of a person at another site represented by decoded image data and is displayed on a monitor, which is the image displaying unit. Thus, the plurality of cameras shoots the persons, and then sets of taken-image data that represent a result of the shooing are coded. The sets of coded taken-image data are transmitted to the other site and decoded there. Users at the other site can feel a strong sense of presence by viewing images represented by the decoded image data. Further, the persons, or users, shot with the cameras can check their own-image properly by viewing a plurality of images of the shot users synthesized with images of the persons at the other site represented by decoded image data. Therefore, usability can be improved. The taken-images represented by the sets of taken-image data generated by the plurality of cameras (own-images) are processed, and then synthesized as processed images. Then, the users taken with the cameras can check their own-images more properly.

The image processing unit may further select one of predetermined image processing methods according to which the image processing unit executes image processing. For example, the image processing unit is configured to select one of the plurality of image processing methods that includes: an image processing method in which the taken-images represented by the sets of taken-image data are individually separated, and the processed image data is generated so that the processed image includes a plurality of the separated taken-images; and an image processing method in which the taken-images represented by the sets of taken-image data are joined, and processed image data is generated to include the plurality of joined taken-images.

Thus, the usability can be further improved by such selecting an image processing method.

The image processing unit may also be configured to generate the processed image data so that a border is set between the plurality of joined images and the decoded image.

Thus, the users can check their own-images more properly owing to the border that has an appearance similar to a frame of a monitor at the other site for displaying images represented by sets of coded taken-image data.

The image processing unit may also be configured to generate the processed image data so that the plurality of joined taken-images is deformed according to a configuration in which another image codec apparatus displays images represented by the sets of taken-image data coded by the coding unit. For example, the image processing unit is configured to generate the processed image data so that the plurality of joined taken-image is deformed to be higher toward ends of the decoded images in a direction in which the plurality of joined taken-images are aligned.

Specifically, in the case where an image codec apparatus at the other site includes three monitors that are aligned to form an arc, images displayed on the monitors look larger toward the lateral ends of the monitors to the users at the other site. The image codec apparatus according to the present invention displays processed images that look similar to the images viewed by the users at the other site by deforming the own-images, which are the plurality of joined taken-images, depending upon a configuration for display in the other codec apparatus. Therefore, the users, who are shot with the cameras, can use images that are similar to the images viewed by the users at the other site for checking their own-images more properly.

The image processing unit may also be configured to obtain, from the another image codec apparatus, display configuration information that indicates the configuration in which the another image codec apparatus displays images and to generate the processed image data according to a configuration indicated by the display configuration information.

Thus, the processed images can be more similar to the images viewed by the users at the other site with more certainty.

The image processing unit may also be configured to generate the processed image data so that a border is provided for each of the plurality of joined images.

Thus, in the case where taken-images represented by sets of coded taken-image data are displayed on separate monitors at the other site, respective borders of a plurality of taken-images included in processed images look similar to the frames of monitors at the other site. Therefore, the users can check their own-images more properly.

The image processing unit may also be configured to select one of the plurality of image processing methods that includes: an image processing method in which only one of the taken-images represented by the sets of taken-image data is extracted, and processed image data is generated to represent the extracted image as the processed image; an image processing method in which processed image data is generated from the taken-images represented by the sets of taken-image data, the processed image data representing, as the processed image, an image different from any of the taken-images; and an image processing method in which processed image data that represents, as the processed image, an image different from the extracted taken-image and any of the processed image. For example, the image processing unit is configured to generate the processed image data so that the image other than any of the taken-images is as if taken from a direction from which neither of the shooting units would take.

Specifically, there are two cameras, which are the shooting units: one shoots a right-front image of a person, and the other shoots a left-front image of the person. In this case, two sets of taken-image data are generated: one represents the right-front image of the person, and the other represents the left-front image of the person.

The present invention selects one of the plurality of image processing methods that includes: a first image processing method in which only either of the taken-images that represents the right-front image and the left-front image of the person respectively is extracted, and a processed image that represents the extracted image is generated; a second image processing method in which a processed image is generated from the taken-images that represents the right-front image and the left front image of the person respectively, and the resultant processed image represents an front image that is different from either of the taken-images; and a third image processing method in which processed images that represent a front image of the person and either of the taken-images that represents the right-front image and the left-front image of the person respectively are generated. Thus, the users can check their own-image more properly.

The present invention can be realized not only as an image codec apparatus, but also as a method, a program, a storage medium that stores such program, or an integrated circuit.

### EFFECTS OF THE INVENTION

An image codec apparatus according to the present invention realizes an advantage that a user can check his own-image properly while feeling a strong sense of presence. In other words, the image codec apparatus displays an easily viewable own-image so that the user can check the own-image properly.

### BRIEF DESCRIPTION OF DRAWINGS

FIG. 1 shows an example of the conventional video conference system (image codec apparatus);

FIG. 2 shows another application example of the conventional video conference system;

FIG. 3A shows an example of an own-image displayed by a conventional video conference system;

FIG. 3B shows another example of an own-image displayed by the conventional video conference system;

FIG. 4A shows an example of another conventional video conference system;

FIG. 4B shows an example of an image displayed by the other conventional video conference system;

FIG. 4C shows another example of an image displayed by the other conventional video conference system;

FIG. 5 shows an example of an own-image displayed by the other conventional video conference system;

FIG. 6 is a schematic drawing of a video conference system including, at each site, an image codec apparatus according to a first embodiment of the present invention;

FIG. 7 shows another example of installation of cameras according to the first embodiment;

FIG. 8 shows another application example of the video conference system according to the first embodiment;

FIG. 9A shows an example of an own-image to be displayed by the video conference system according to the first embodiment;

FIG. 9B shows another example of an own-image to be displayed by the video conference system according to the first embodiment;

FIG. 9C shows another example of an own-image to be displayed by the video conference system according to the first embodiment;

FIG. 9D shows another example of an own-image to be displayed by the video conference system according to the first embodiment;

FIG. 10A is a block diagram showing an example of the configuration of the image codec apparatus included in a site of the video conference system according to the first embodiment;

FIG. 10B shows an internal configuration of a synthesizer according to the first embodiment;

FIG. 11 is a flowchart showing operation of the image codec apparatus 100 according to the first embodiment;

FIG. 12 is a block diagram showing an example of the configuration of the image codec apparatus included in a site of the video conference system according to a first variation of the first embodiment;

FIG. 13A shows an example of an image to be displayed by the image codec apparatus according to a second variation of the first embodiment;

FIG. 13B shows another example of an image to be displayed by the image codec apparatus according to the second variation of the first embodiment;

FIG. 14 shows an example of an own-image frame to be displayed by the image codec apparatus according to the second variation of the first embodiment;

FIG. 15 is a schematic drawing of a video conference system including, at each site, an image codec apparatus according to a second embodiment of the present invention;

FIG. 16A shows an image to be displayed on a monitor according to the second embodiment;

FIG. 16B shows another image to be displayed on a monitor according to the second embodiment;

FIG. 16C shows images to be displayed on two monitors according to the second embodiment;

FIG. 17A shows an example of own-images to be displayed in the video conference system according to the second embodiment;

FIG. 17B shows another example of an own-image to be displayed in the video conference system according to the second embodiment;

FIG. 17C shows another example of an own-image to be displayed in the video conference system according to the second embodiment;

FIG. 17D shows another example of an own-image to be displayed in the video conference system according to the second embodiment;

FIG. 18 is a block diagram showing an example of the configuration of the image codec apparatus included in a site of the video conference system according to the second variation;

FIG. 19A shows a case where the image codec apparatus according to a third embodiment to be realized on a computer system;

FIG. 19B further shows a case where the image codec apparatus according to the third embodiment to be realized on the computer system; and

FIG. 19C further shows a case where the image codec apparatus according to the third embodiment to be realized on the computer system.

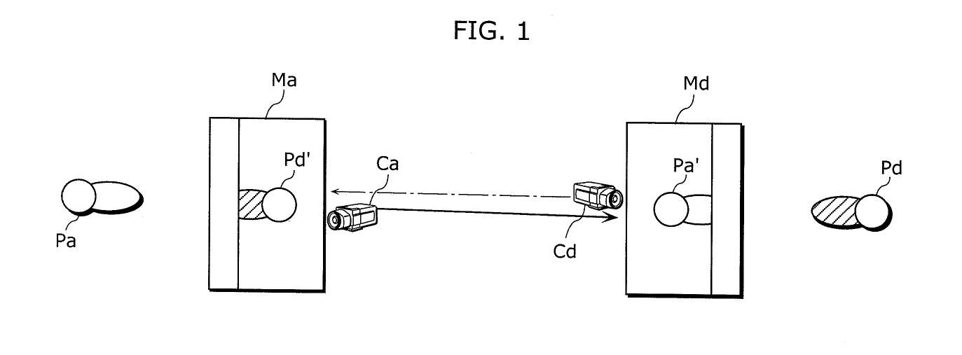

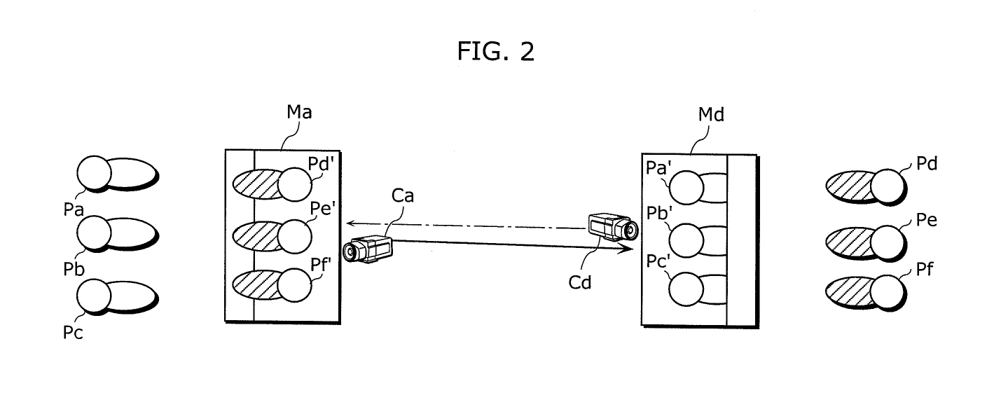

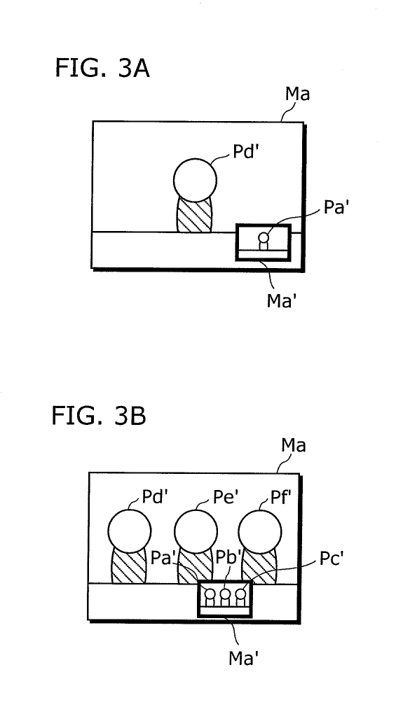

### NUMERICAL REFERENCES

101, 102, 103 Encoder
111, 112, 113 Synthesizer
121, 122, 123 Decoder
130 Switching controller
Ca, Cb, Cc Camera
Ma, Mb, Mc Monitor
Cs Computer system
FD Flexible disk body
FDD Flexible disk drive

### BEST MODE FOR CARRYING OUT THE INVENTION

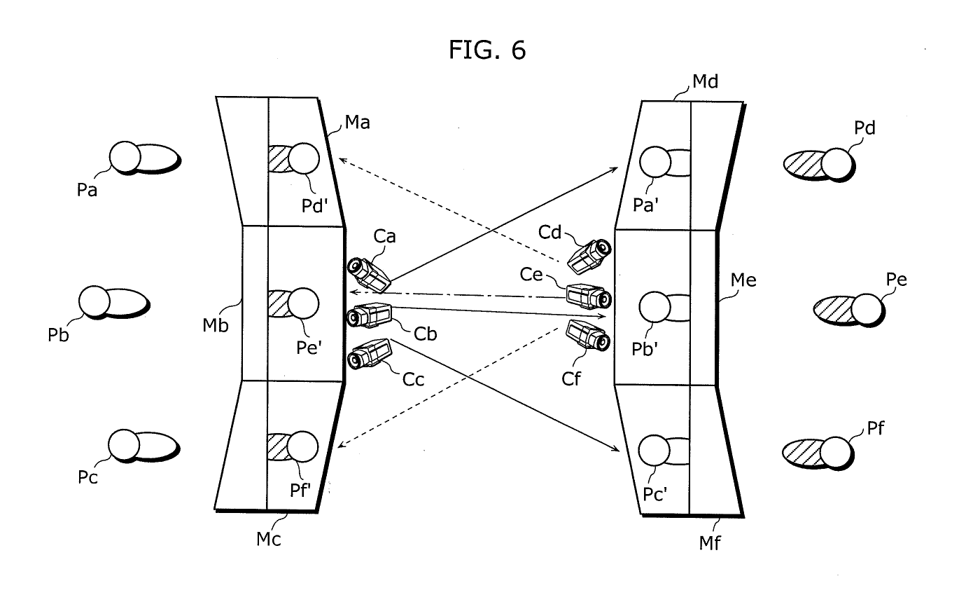

Hereinafter, embodiments of the present invention are described with reference to FIGS. 6 to 19C.

The present description describes a system at each site of video conference systems as an example of image codec apparatuses, because video conference systems are typical of image communication systems associated with images and voice. It is obvious that image codec apparatuses of the present invention are applicable also to videophones and video surveillance systems.

### First Embodiment

FIG. 6 is a schematic drawing of a video conference system including, at each site, an image codec apparatus according to a first embodiment of the present invention.

The image codec apparatus includes a three-panel monitor and is configured as a system for a site of the video conference system. FIG. 6 shows an example where the video conference system in the first embodiment is used by six persons.

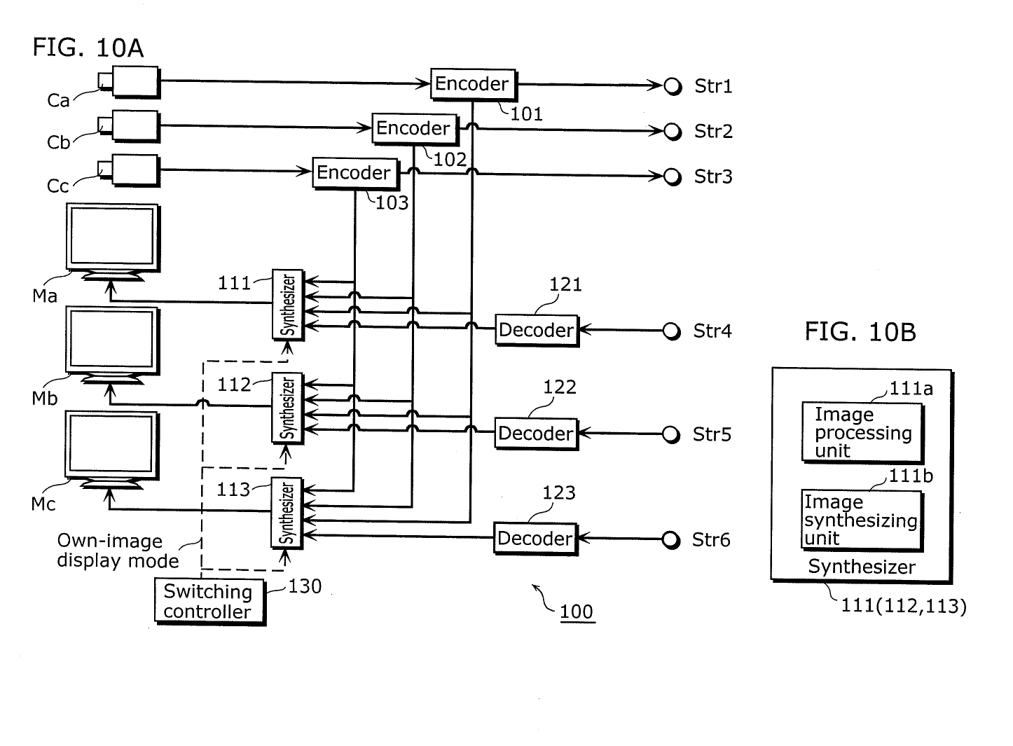

The video conference system shown in the first embodiment includes two sites (image codec apparatuses). One site has cameras Ca, Cb, and Cc as shooting units, monitors Ma, Mb, and Mc as image displaying units, encoders, decoders, and synthesizers (see FIG. 10A). The other site has cameras Cd, Ce, and Cf as shooting units, monitors Md, Me, and Mf as image displaying units, encoders, decoders, and synthesizers (see FIG. 10A).

The monitors Ma, Mb, Mc, Md, Me, and Mf are, for example, plasma display panels (PDPs). The encoders, decoders, and synthesizers will be described later.

The monitor Ma is installed in front of a person Pa. The monitor Mb is installed in front of a person Pb. The monitor Mc is installed in front of a person Pc. The monitor Md is installed in front of a person Pd. The monitor Me is installed in front of a person Pe. The monitor Mf is installed in front of a person Pf.

The cameras Ca, Cb, and Cc are installed at the monitor Mb, and the cameras are pointed in the directions such that the cameras can shoot the persons Pa, Pb, and Pc, respectively. An output terminal of the camera Ca is connected to the monitor Md. An output terminal of the camera Cb is connected to the monitor Me. An output terminal of the camera Cc is connected to the monitor Mf. The cameras Cd, Ce, and Cf are installed at the monitor Me, and the cameras are pointed in the directions such that the cameras can shoot the persons Pd, Pe, and Pf, respectively. An output terminal of the camera Cd is connected to the monitor Ma. An output terminal of the camera Ce is connected to the monitor Mb. An output terminal of the camera Cf is connected to the monitor Mc. Thus, the monitors Ma, Mb, and Mc display images Pd′, Pe′, and Pf′ of the persons Pd, Pe, and Pf, respectively. The monitors Md, Me, and Mf display images Pa′, Pb′, and Pc′ of the persons Pa, Pb, and Pc, respectively.

Specifically, the three respective cameras (for example, cameras Ca, Cb, and Cc) in the image codec apparatus (the system at each site) in the first embodiment, shoot in order to generate taken-image data that represent taken-images, and then output the taken-image data. The encoders code the taken-image data and transmit the taken-image data to the image codec apparatus at the other site. The decoders obtain, from the image codec apparatus at the other site, coded image data that represent taken-images taken at the other site, and decode the coded image data in order to generate decoded image data. The monitors (for example, the monitors Ma, Mb, and Mc) display decoded images that are represented by the decoded image data transmitted from the decoders.

The configuration described above enables the users, the persons Pa, Pb, and Pc, to feel as if they were facing the persons Pd, Pe, and Pf, respectively. In other words, using three cameras and three monitors for each site provides a wider image area (especially in the horizontal direction of a view field) than using one camera and one monitor does, and realizes a strong sense of presence as if the users had their counterparts in front of themselves.

The first embodiment also allows collective installation of camera fixing equipment (such as a tripod) and/or video equipment provided with cameras because the cameras are installed at one place (one monitor). Installation positions and directions of the cameras may be otherwise than as shown in FIG. 6.

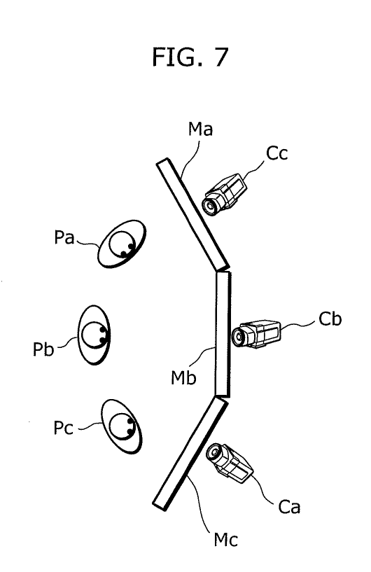

FIG. 7 shows another example of installation of the cameras. In the example shown in FIG. 7, the cameras are respectively installed at each monitor. This layout is appropriate for the case where space is too small to install a plurality of cameras at one place (one monitor) collectively. As shown in FIG. 7, the cameras Ca, Cb, and Cc are pointed toward the persons Pa, Pb, and Pc, respectively. These cameras can take approximately the same images as the images taken with the cameras Ca, Cb, and Cc installed in the positions shown in FIG. 6.

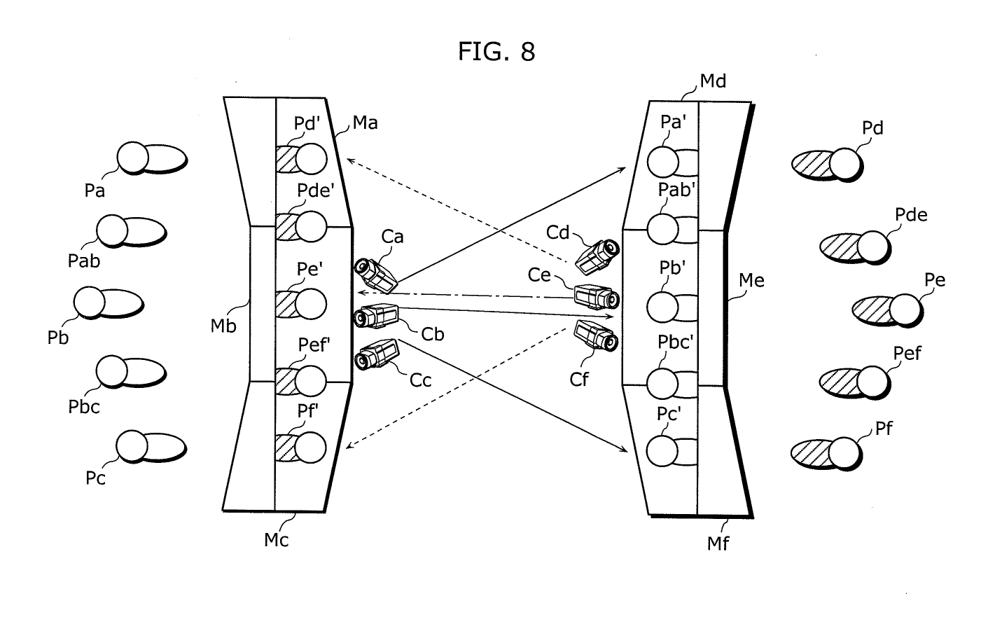

FIG. 8 shows another application example of the video conference system according to the first embodiment.

In the application example shown in FIG. 8, the video conference system that includes a three panel monitor for each site is used by ten persons. Installation and connection of the cameras and the monitors shown in FIG. 8 are identical to those shown in FIG. 6.

Accordingly, the persons Pa, Pb, and Pc are shot with the cameras Ca, Cb, and Cc, respectively, and their images Pa′, Pb′, and Pc′ are displayed on the monitors Md, Me, and Mf, respectively. Similarly, the persons Pd, Pe, and Pf are shot with the cameras Cd, Ce, and Cf, respectively, and their images Pd′, Pe′, and Pf′ are displayed on the monitors Ma, Mb, and Mc, respectively.

A person Pab is shot with both of the cameras Ca and Cb because of the position of the person Pab that extends between shooting areas of the cameras Ca and Cb. A taken-image Pab′ of the person Pab is split into two images, and the two images are displayed on the monitors Md and Me, respectively. Similarly, a person Pbc is shot with both of the cameras Cb and Cc. A taken-image Pbc′ of the person Pbc is split into two images, and the two images are displayed on the monitors Me and Mf, respectively. A person Pde is shot with both of the cameras Cd and Ce. A taken-image Pde′ of the person Pde is split into two images, and the two images are displayed on the monitors Ma and Mb, respectively. A person Pef is shot with both of the cameras Ce and Cf. A taken-image Pef′ of the person Pef is split into two images, and the two images are displayed on the monitors Mb and Mc, respectively.

Thus, the video conference system according to the first embodiment enables the five users, the persons Pa, Pab, Pb, Pbc, and Pc, to feel as if they were facing the persons Pd, Pde, Pe, Pef, and Pf, respectively, even when the video conference system has five users at each site. In the case where each site has five persons, they line up (taking their seats) laterally, occupying a wider area than where each site has three persons. In the first embodiment, using three cameras and three monitors for each site provides a wider image area (especially in the horizontal direction of a view field) than using one camera and one monitor does. Therefore, the present invention is suitable for meetings of more participants, realizing the strong sense of presence as if the participants had their counterparts in front of themselves.

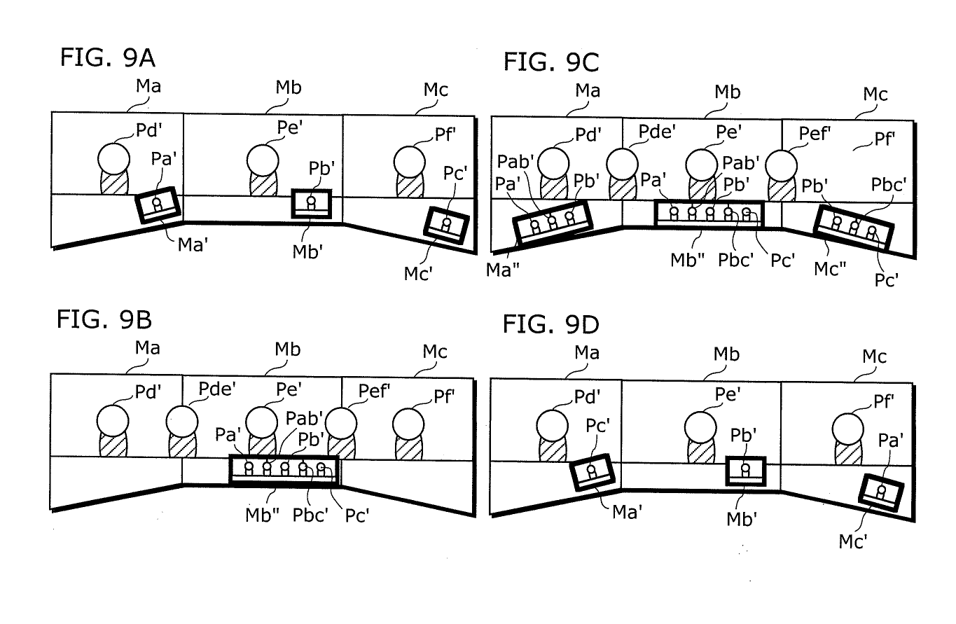

FIGS. 9A to 9D show examples of own-images to be displayed in the video conference system according to the first embodiment. Own-images are images for users to check how their images taken with cameras are displayed. In other words, own-images are images taken with cameras at a site and displayed on monitors at the site.

In the case where a video conference involves three persons at each site as shown in FIG. 6, the monitors Ma, Mb, and Mc are installed in front of the persons Pa, Pb, and Pc, respectively. As shown in FIG. 9A, displaying on each monitor the own-image of the person only in front of the monitor excludes unnecessary own-images of the other persons and increases an area to display an image of his counterpart in the video conference, thus making the image more easily viewable. Specifically, the monitor Ma displays an image taken with the camera Ca in an own-image frame Ma′; thus, an own-image that includes an image Pa′ of the person Pa is displayed in the own-image frame Ma′. Similarly, the monitor Mb displays an image taken with the camera Cb in an own-image frame Mb′; thus, an own-image that includes an image Pb′ of the person Pb is displayed in the own-image frame Mb′. Similarly, the monitor Mc displays an image taken with the camera Cc in an own-image frame Mc′; thus, an own-image that includes an image Pc′ of the person Pc is displayed in the own-image frame Mc′.

In the case where the video conference involves five persons at each site as shown in FIG. 8, the person Pab is shot with the cameras Ca and Cb, and the person Pbc is shot with the cameras Cb and Cc. In this case, displaying the own-images in the same way as shown in FIG. 9A will split the own-images of the persons respectively into two pieces (for example, into a right half and a left half), and each of their own-images will be displayed across the two monitors. Such split own-images are not easily viewable. In such a case where a person is shot with a plurality of cameras, images taken with all the cameras may be joined and put into a single own-image frame Mb″ where all the own-images are displayed, as shown in FIG. 9B. Thus, the person shot with the plurality of cameras respectively can check his own-image in an own-image frame.

In the case where images taken with the plurality of cameras are joined and displayed as a continuous own-image, images taken with only some (two) of all the (three) cameras can be joined and displayed on the monitors respectively along with an image obtained by joining images taken with all the three cameras, as shown in FIG. 9C.

Specifically, the images taken with the cameras Ca and Cb are joined and displayed in an own-image frame Ma″ on the monitor Ma. Thus, displayed continuously in the own-image frame Ma″ are an own-image including an image Pa′ of the person Pa and one half of an image Pab′ of the person Pab, and an own-image including the other half of the image Pab′ of the person Pab and an image Pb′ of the person Pb.

Images taken with the cameras Ca, Cb, and Cc are joined and displayed in an own-image frame Mb″ on the monitor Mb. Thus, displayed continuously in the own-image frame Mb″ are the own-image including the image Pa′ of the person Pa and one half of the image Pab′ of the person Pab, the own-image including the other half of the image Pab′ of the person Pab, the image Pb′ of the person Pb, and one half of the image Pbc′ of the person Pbc, and an own-image including the other half of the image Pbc′ of the person Pbc and the image Pc′ of the person Pc.

Images taken with the cameras Cb and Cc joined and displayed in an own-image frame Mc″ on the monitor Mc. Thus, displayed continuously in the own-image frame Mc″ are an own-image including an image Pb′ of the person Pb and one half of an image Pbc′ of the person Pbc, and an own-image including the other half of the image Pbc′ of the person Pbc and an image Pc′ of the person Pc.

In the case of a roundtable-format conference, an own-image of a user can be displayed not on the monitor closest to the user, but on the monitor that displays a person across a table from the user as shown in FIG. 9D. Specifically, for the person Pa, an own-image including an image Pa′ of the person Pa may be displayed not on the monitor Ma closest to the person Pa but on the monitor Mc that displays an image Pf′ of the person Pf across the table from the person Pa. The reason is that persons along two parallel sides of a rectangular table respectively are opposite to each other in a direction perpendicular to the two parallel sides, whereas persons facing each other around a round table are opposite to each other across the center of the round table.

Thus, in displaying an own-image, the image codec apparatus in the video conference system according to the first embodiment selects a configuration in which the own-images are displayed as shown in FIGS. 9A to 9D.

Specifically, the image codec apparatus in the video conference system according to the first embodiment includes an image processing unit (see FIG. 10B) for generating processed image data by executing image processing on taken-image data generated by the three cameras. The processed image data represents a processed image obtained as a result of adjusting arrangement of three own-images. Examples of such processed image include the three own-image frames Ma′, Mb′, and Mc′, and the images in these frames shown in FIG. 9A; the own-image frame Mb″ and the image in this frame shown in FIG. 9B; the three own-image frames Ma″, Mb″, Mc″, and the images in these frames shown in FIG. 9C; and the three own-image frames Ma′, Mb′, Mc′, and the images in these frames shown in FIG. 9D.

The image processing unit in the video conference system according to the first embodiment selects one of four image processing methods, and then, according to the selected image processing method, generates processed image data that represents a processed image as described above. The image codec apparatus in the video conference system according to the first embodiment has also an image synthesizing unit (see FIG. 10B). The image synthesizing unit synthesizes the processed image that is represented by the processed image data with the decoded image that has been originally taken at the other site and is represented by the decoded image data. The image synthesizing unit outputs synthesized image data that represents a synthesized image. The monitors (for example, the monitor Ma, Mb, and Mc) obtain the synthesized image data as image display data, and then display, as shown in FIGS. 9A to 9D, images represented by the image display data.

The image codec apparatus in the video conference system according to the first embodiment includes also a switching unit (switching controller in FIG. 10A) that switches data to be obtained as image display data by monitors between the synthesized image data outputted from the image synthesizing unit and the decoded image data generated by the decoder. The switching unit switches between the data according to, for example, a user operation. Therefore, display of processed images on the three monitors switches between enabled and disabled states.

Further, the image processing unit selects one image processing method from the four image processing methods according to, for example: (i) an explicit instruction on selection by a user; (ii) a usage history and/or a preference of a user; (iii) the number of persons (one or plural) being shot with the cameras; and (iv) presence or absence of a person shot with a plurality of the cameras concurrently. In the case with (ii) above, for example, the image processing unit manages, as a history, image processing methods selected by each user, and automatically selects one of the image processing methods that has been selected by a user frequently. The image processing unit may select one of the image processing methods also according to a result of a combination of above-mentioned (i) to (iv).

Each site (image codec apparatus) in the first embodiment has three cameras and three monitors; having two or more cameras is sufficient. Optionally, having a single monitor is also sufficient, and a curved monitor is also applicable.

FIG. 10A is a block diagram showing an example of a configuration of the image codec apparatus included in a site of the video conference system according to the first embodiment.

An image codec apparatus 100 in the video conference system codes images taken with cameras and transmits the coded taken-images to the site of the counterparts, while decoding the coded taken-images to display them as own-images.

Specifically, the image codec apparatus 100 includes the cameras Ca, Cb, and Cc, the monitors Ma, Mb, and Mc, the encoders 101, 102, and 103, the decoders 121, 122, and 123, the synthesizers 111, 112, and 113, and the switching controller 130.

The encoder 101 codes taken-image data that represents a taken-image taken with the camera Ca, and then transmits a bitstream generated through the coding as a stream Str1 to the site of the counterparts. The encoder 101 also decodes the stream Str1 to generate an own-image, and then outputs, to the synthesizers 111, 112, and 113, the generated own-image, in other words, the taken-image data (the taken-image) that has been once coded and then decoded.

The encoder 102 codes taken-image data that represents a taken-image taken with the camera Cb, and then transmits a bitstream generated through the coding as a stream Str2 to the site of the counterparts. The encoder 102 also decodes the stream Str2 to generate an own-image, and then outputs, to the synthesizers 111, 112, and 113, the generated own-image, in other words, the taken-image data (the taken-image) that has been once coded and then decoded.

The encoder 103 codes taken-image data that represents a taken-image taken with the camera Cc, and then transmits a bitstream generated through the coding as a stream Str3 to the site of the counterparts. The encoder 103 also decodes the stream Str3 to generate an own-image, and then outputs, to the synthesizers 111, 112, and 113, the generated own-image, in other words, the taken-image data (the taken-image) that has been once coded and then decoded.

Bitstreams generated by coding images taken at the site of the counterparts are inputted into the image codec apparatus 100 as streams Str4, Str5, and Str6.

Specifically, the decoder 121 obtains coded image data as the stream Str4, decodes the stream Str4 to generate decoded image data, and then outputs the decoded image data to the synthesizer 111.

The synthesizer 111 obtains, from the switching controller 130, an own-image display mode that indicates whether or not the own-image (a processed image) is to be displayed, and which image processing method is to be applied to. Subsequently, the synthesizer 111 processes three own-images (the taken-image data) outputted from the encoders 101, 102, and 103. Specifically, the synthesizer 111 selects one of the three own-images (the taken-image data) according to the own-image display mode.

When the synthesizer 111 selects a plurality of the own-images, the selected own-images are joined into a single image. The synthesizer 111 also synthesizes (superimposes) the processed own-image (the processed image) on a decoded image that is represented by the image data and generated through the decoding by the decoder 121, and then outputs a synthesized image to the monitor Ma.

When the own-image display mode indicates that the own-image (the processed image) is not to be displayed, the synthesizer 111 outputs the decoded image data that is obtained from the decoder 121, as image display data to the monitor Ma without processing the taken-image data or synthesizing the decoded image.

Similarly, the decoder 122 obtains coded image data as a stream Str5, decodes the stream Str5 to generate decoded image data, and then outputs the decoded image data to the synthesizer 112.

The synthesizer 112 obtains, from the switching controller 130, an own-image display mode that indicates whether or not the own-image (a processed image) is to be displayed, and which image processing method is to be applied to. Subsequently, the synthesizer 112 processes the own-images (the taken-image data) outputted from the encoders 101, 102, and 103, according to the own-image display mode. The synthesizer 112 also synthesizes (superimposes) the processed own-image (the processed image) on a decoded image that is represented by the image data and generated through decoding by the decoder 122, and then outputs a synthesized image to the monitor Mb.

Similarly, the decoder 123 obtains coded image data as a stream Str6, decodes the stream Str6 to generate decoded image data, and then outputs the decoded image data to the synthesizer 113.

The synthesizer 113 obtains, from the switching controller 130, an own-image display mode that indicates whether or not an own-image (the processed image) is to be displayed, and which image processing method is to be applied to. Subsequently, the synthesizer 113 processes the own-images (the taken-image data) outputted from the encoders 101, 102, and 103, according to the own-image display mode. The synthesizer 113 also synthesizes (superimposes) the processed own-image (the processed image) on a decoded image that is represented by the image data and generated through decoding by the decoder 123, and then outputs a synthesized image to the monitor Mc.

The switching controller 130 judges whether or not the own-image (the processed image) is displayed, according to, for example, a user operation that the switching controller 130 has received. The switching controller 130 also selects, using a usage history, a preference of a user, and the like described above, one image processing method from the image processing methods shown in FIGS. 9A to 9D. Then, the switching controller 130 transmits, to the synthesizers 111, 112, and 113, an own-image display mode that indicates whether or not an own-image is to be displayed and which image processing method has been selected.

FIG. 10B shows an internal configuration of the synthesizer 111.

The synthesizer 111 includes an image processing unit 111a and an image synthesizing unit 111b.

The image processing unit 111a obtains an own-image display mode from the switching controller 130. When the own-image display mode indicates that an own-image (processed image) is to be displayed, the image processing unit 111a executes the above-described image processing on taken-image data obtained from the encoders 101, 102, and 103, in other words, taken-image data that has been once encoded and then decoded. The image processing unit 111a then outputs, to image synthesizing unit 111b, processed image data generated in the image processing. Here, the own-image display mode indicates one of the four image processing methods described above. The image processing unit 111a executes the image processing according to the image processing method that the own-image display mode indicates. When the own-image display mode indicates that display of an own-image (processed image) is disabled, the image processing unit 111a does not execute the image processing described above.

The image synthesizing unit 111b obtains decoded image data from the decoder 121. When obtaining also the processed image data from the image processing unit 111a, the image synthesizing unit 111b synthesizes (superimposes) a processed image represented by the processed image data, in other words a processed own-image, on a decoded image represented by the decoded image data. The image synthesizing unit 111b outputs, as image display data, synthesized image data generated through the synthesizing to the monitor Ma. When an own-image is not to be displayed, the image synthesizing unit 111b neither obtains processed image data from the image processing unit 111a nor synthesizes decoded image data obtained from the decoder 121, but only does output the decoded image data as image display data to the monitor Ma.

The synthesizers 112 and 113 have the same configuration as the synthesizer 111 has as described above.

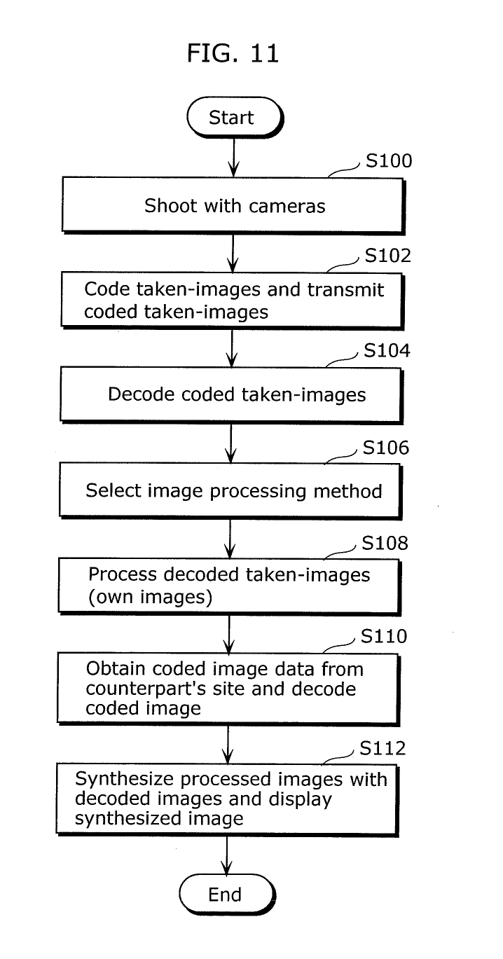

FIG. 11 is a flowchart showing operation of the image codec apparatus 100 according to the first embodiment.

The image codec apparatus 100 shoots with the three cameras Ca, Cb, and Cc to generate taken-images (taken-image data) (Step S100). Subsequently, the image codec apparatus 100 codes the generated taken-images and transmits the coded taken-images to another image codec apparatus at a site of a counterpart (Step S102).

The image codec apparatus 100 then decodes the coded images to generate own-images (Step S104). Here, the image codec apparatus 100 selects, according to a user operation and the like, an image processing method to be applied to the decoded taken-images, in other words, the own-images (Step S106). The image codec apparatus 100, according to the selected image processing method, processes the decoded taken-images, in other words the own-images, to generate processed images (processed image data) (Step S108).

The image codec apparatus 100 also obtains coded image data that have been taken and coded at the site of the counterparts, and decodes the coded image data to generate decoded images (Step S110).

The image codec apparatus 100 finally synthesizes the processed images generated in Step S108 on the decoded images generated in Step S110, and displays a synthesized image on the monitors Ma, Mb, and Mc.

Thus, the first embodiment processes own-images of users, in other words taken-images taken with a plurality of cameras, and then displays the own-images on monitors as processed images; therefore, the users shot with the cameras can check their own-images properly.

The first embodiment allows the users to use own-images generated through coding and decoding taken-images so that they can properly check their own-images that reflect coding distortion of the image codec apparatus.

(First Variation)

Hereinafter, the configuration of the image codec apparatus in a first variation of the first embodiment will be described.

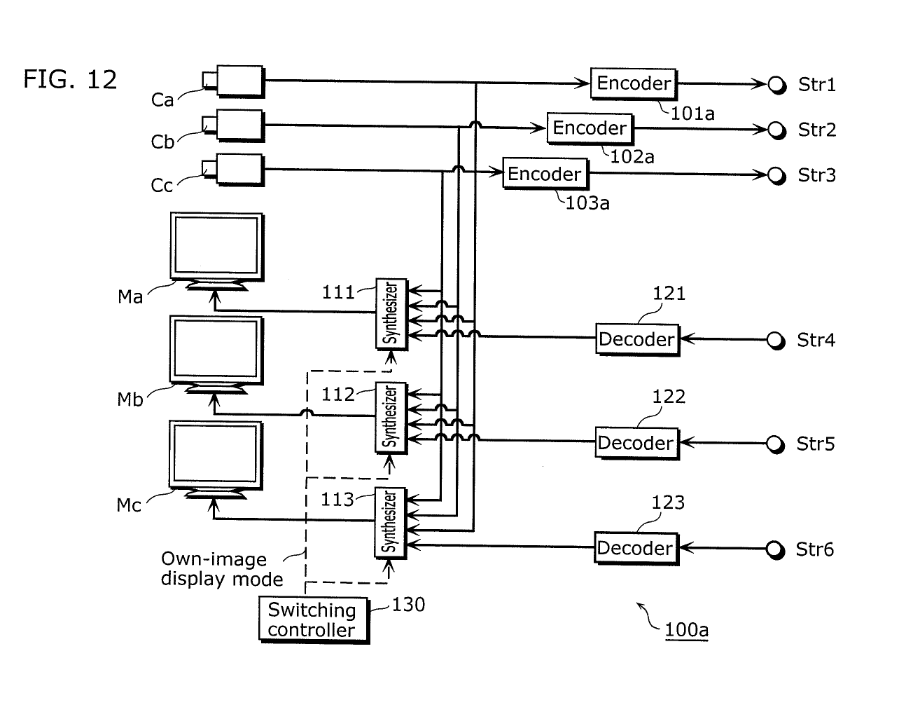

FIG. 12 is a block diagram showing an example of the configuration of the image codec apparatus included in a site of the video conference system according to the first variation.

An image codec apparatus 100a in the video conference system displays taken-images taken with the cameras as own-images without encoding or decoding the taken-images.

Specifically, the image codec apparatus 100a includes the cameras Ca, Cb, and Cc, the monitors Ma, Mb, and Mc, encoders 101a, 102a, and 103a, the decoders 121, 122, and 123, the synthesizers 111, 112, and 113, and the switching controller 130. In other words, the image codec apparatus 100a includes the encoders 101a, 102a, and 103a instead of the encoders 101, 102, and 103 that are included in the image codec apparatus 100 in the first embodiment described above.

The encoder 101a codes taken-image data that represents a taken-image taken with the camera Ca and then transmits a bitstream generated through the coding as a stream Str1 to the site of the counterparts. Unlike the encoder 101 in the first embodiment, the encoder 101a according to the first variation does not decode the stream Str1.

Similarly, the encoder 102a codes taken-image data that represents a taken-image taken with the camera Cb, and then transmits a bitstream generated through the coding as a stream Str2 to the site of the counterparts. Unlike the encoder 102 in the first embodiment, the encoder 102a according to the first variation does not decode the stream Str2.

Similarly, the encoder 103a codes taken-image data that represents a taken-image taken with the camera Cc, and then transmits a bitstream generated through the coding as a stream Str3 to the site of the counterparts. Unlike the encoder 103 in the first embodiment, the encoder 103a according to the first variation does not decode the stream Str3.

Therefore, unlike the first embodiment, the synthesizers 111, 112, and 113 according to the first variation obtain not taken-image data that has been once coded and then decoded, but taken-image data outputted from the cameras Ca, Cb, and Cc directly.

Thus, in the first variation, using images taken with the cameras as own-images without coding and decoding the images does not allow users to check deterioration in image quality due to the image codec processing, but shortens response time from taking images with the cameras to displaying the images without being affected by a delay because of CODEC processing time.

(Second Variation)

Hereinafter, the image processing method in a second variation of the first embodiment will be described. The image codec apparatus 100 in the second variation generates a processed image that allows a user to check his own-image more properly.

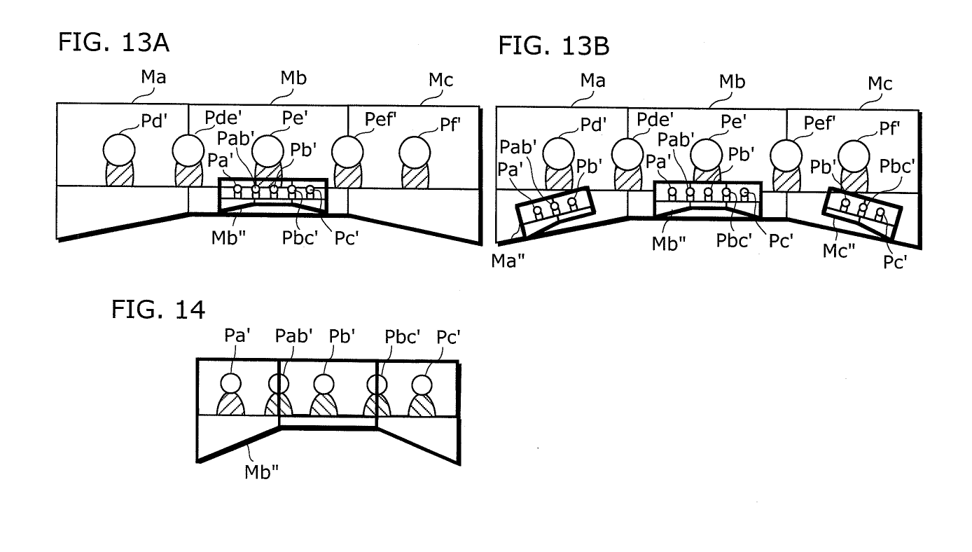

FIG. 13A shows an example of an image to be displayed by the image codec apparatus 100 according to the second variation.

The image codec apparatus 100 according to the second variation generates a processed image to be displayed. The processed image has a height that increases toward the both lateral ends of the processed image as shown in FIG. 13A. The processed image includes an own-image frame Mb″ that has a height increasing toward the both lateral ends of the own-image frame and three own-images that are deformed to fit in the own-image frame Mb″. A first own-image of the three own-images includes the image Pa′ of the person Pa and one half of the image Pab′ of the person Pab. A second own-image of the three own-images includes the other half of the image Pab′ of the person Pab, the image Pb′ of the person Pb, and one half of the image Pbc′ of the person Pbc. A third own-image of the three own-images includes the other half of the image Pbc′ of the person Pbc and the image Pc′ of the person Pc. These three own-images are continuously joined. The first own-image is formed to be higher toward the left of FIG. 13A. The second own-image is formed to be higher toward the right of FIG. 13A. The own-image frame Mb″ sets a border between the three continuous own-images and a decoded image.

In the case where the three monitors are installed as shown in FIG. 7, the users will feel that the images on the monitors that are closer to the users (in other words, the endmost ones of the three monitors) respectively, look larger than the image on the middle monitor that is relatively far from the users. The image codec apparatus 100 included in the site of the video conference system according to the second variation displays the middle own-image smaller than the endmost own-images so that a generated processed image looks more similar to an image taken at the site and viewed at the site of the counterparts.

Specifically, the image processing unit 111a of the synthesizer 111 in the image codec apparatus 100 obtains decoded image data from the decoder 121, and then outputs the decoded image data as image display data to the monitor Ma without processing taken-image data that the image processing unit 111a has obtained from the encoders 101, 102, and 103. Similarly, the image processing unit of the synthesizer 113 in the image codec apparatus 100 obtains decoded image data from the decoder 123, and then outputs the decoded image data as image display data to the monitor Mc without processing taken-image data that the image processing unit of the synthesizer 113 has obtained from the encoders 101, 102, and 103.

On the other hand, the image processing unit of the synthesizer 112 in the image codec apparatus 100 generates processed image data that represents, as a processed image, an own-image frame Mb″ and own-images represented by the taken-image data that the image processing unit of the synthesizer 112 has obtained from the encoders 101, 102, and 103. In generating the processed image data, the image processing unit deforms the three own-images so that the three own-images become higher continuously toward the both lateral ends of the own-images. The image processing unit of the synthesizer 112 then generates synthesized image data that represents a synthesized image by synthesizing the processed image represented by the processed image data with the decoded image represented by the decoded image data. The image processing unit outputs the resultant synthesized image data as image display data to the monitor Mb.

In other words, the image processing unit of the synthesizer 112 according to the second variation deforms the three continuous own-images according to the configurations in which the image codec apparatus at the site of the counterparts displays the image represented by the steams Str1, Str2, and Str3. For example, the image processing unit deforms the continuous own-images depending on layout, sizes, and the like of the three monitors of the image codec apparatus at the site of the counterparts so that the processed image corresponds to the image that the users at the site of the counterparts view. The above-described image processing unit may obtain, from the image codec apparatus at the site of the counterparts, information on the display configuration (display configuration information) of the image codec apparatus, and deform the own-images according to the obtained information. The information indicates, for example, layout, sizes, numbers, and models of the monitors, as mentioned above.

Thus, the image codec apparatus 100 according to the second variation allows the users (the persons Pa, Pb, and Pc) to check more properly how their images are displayed at the site of their counterparts. FIG. 13B shows another example of an image to be displayed by the image codec apparatus 100 according to the second variation.

The image codec apparatus 100 according to the second variation generates a middle processed image, a left processed image, and a right processed image to be displayed as shown in FIG. 13B. The middle image has a height that increases toward the both lateral ends of the middle processed image. The left processed image includes one portion of the middle processed image. The right processed image includes the other portion of the middle processed image.

The left processed image includes an own-image frame Ma″ having a height that increases toward the left of FIG. 13B and two own-images deformed to fit in the own-image frame Ma″. A first own-image of the two own-images includes the image Pa′ of the person Pa and one half of the image Pab′ of the person Pab. A second own-image of the two own-images includes the other half of the image Pab′ of the person Pab and the image Pb′ of the person Pb. These two own-images are continuously joined.

The right processed image includes an own-image frame Mc″ having a height that increases toward the right of FIG. 13B and two own-images deformed to fit in the own-image frame Mc″. A first own-image of the two own-images includes the image Pb′ of the person Pb and one half of the image Pbc′ of the person Pbc. A second own-image of the two own-images includes the other half of the image Pbc′ of the person Pbc and the image Pc′ of the person Pc. These two own-images are continuously joined.

Specifically, the image processing unit 111a of the synthesizer 111 in the image codec apparatus 100 generates processed image data that represents, as a processed image, an own-image frame Ma″ and own-images represented by the taken-image data that the image processing unit 111a has obtained from the encoders 101 and 102. In generating the processed image data, the image processing unit 111a deforms the two own-images so that the two own-images become higher continuously toward the left end of the own-images. The image processing unit 111a of the synthesizer 112 then generates synthesized image data that represents a synthesized image by synthesizing the processed image represented by the processed image data with the decoded image represented by the decoded image data that the image processing unit 111a has obtained from the decoder 121. The image processing unit 111a outputs the resultant synthesized image data as image display data to the monitor Ma.

Similarly, the image processing unit of the synthesizer 113 in the image codec apparatus 100 generates processed image data that represents, as a processed image, an own-image frame Mc″ and own-images represented by the taken-image data that the image processing unit of the synthesizer 113 has obtained from the encoders 102 and 103. In generating the processed image data, the image processing unit deforms the three own-images so that the two own-images become higher continuously toward the right end of the own-images. The image processing unit of the synthesizer 113 then generates synthesized image data that represents a synthesized image by synthesizing the processed image represented by the processed image data with the decoded image represented by the decoded image data that the image processing unit of the synthesizer 113 has obtained from the decoder 123. The image processing unit outputs the resultant synthesized image data as image display data to the monitor Mc.

Similarly, the image processing unit of the synthesizer 112 in the image codec apparatus 100 generates processed image data that represents, as a processed image, an own-image frame Mb″ and own-images represented by the taken-image data that the image processing unit of the synthesizer 112 has obtained from the encoders 101, 102, and 103. In generating the processed image data, the image processing unit deforms the three own-images so that the three own-images become higher continuously toward the both lateral ends of the own-images. The image processing unit of the synthesizer 112 synthesizes the processed image represented by the processed image data with the decoded image represented by the decoded image data to generate synthesized image data that represents a synthesized image. The image processing unit outputs the resultant synthesized image data as image display data to the monitor Mb.

Thus, even when the middle processed image (own-image) displayed on the monitor Mb diagonally in front of the persons Pa and Pc includes their images, the persons Pa and Pc can use not the middle processed image but the left and right processed images on the monitors Ma and Mc in front of the persons Pa and Pc respectively, for checking how their images are displayed at the site of their counterpart. In other words, the persons Pa and Pc in front of the monitors Ma and Mc respectively can check more properly and easily how their images are displayed at the site of their counterpart.

Here, the image codec apparatus according to the second variation may generate own-image frames Ma″, Mb″, and Mc″ that represent frames of the monitors at the site of the counterparts.

FIG. 14 shows an example of an own-image frame.

The image processing units of the synthesizers 111, 112, and 113 obtain three taken-image data from the encoders 101, 102, and 103, and then make a selection from the three taken-image data according to the own-image display mode. Subsequently, the image processing unit generates the own-image frames Ma″, Mb″, and Mc″ that individually border with a heavy line an own-image represented by the selected taken-image data. When a plurality of own-images are selected, the own-image frames Ma″, Mb″, and Mc″ generated by the image processing units border each of the own-images with a heavy line.

For example, the image processing unit of the synthesizer 112 generates the own-image frame Mb″ that borders each of the three own-images with a heavy line as shown in FIG. 14. In other words, the heavy line of the own-image frame Mb″ defines the first own-image that includes the image Pa′ of the person Pa and one half of the image Pab′ of the person Pab. Further, the heavy line of the own-image frame Mb″ defines the second own-image that includes the other half of the image Pab′ of the person Pab, the image Pa′ of the person Pa, and one half of the image Pbc′ of the person Pbc. Further, the heavy line define the third own-image that includes the other half of the image Pbc′ of the person Pbc and the image Pc′ of the person Pc.

Thus, the second variation allows the users of the image codec apparatus 100 (the persons Pa, Pb, and Pc) to check even more properly how their images are displayed at the site of their counterparts. For example, the users can visually check whether or not their images are on a border between the monitors and judge whether they should move their seat positions.

When generating an own-image frame that will border each of two continuous own-images with the heavy line, the image processing units of the synthesizers 111, 112, and 113 display the own-images so that the facing edges of the two own-images are the two heavy lines width apart from each other. When the two own-images individually bordered with the heavy line are aligned continuously, for example, an image of a person displayed across the two own-images (for example, the image Pab′ in FIG. 14) looks wider than when displayed in a single own-image by the width of the two heavy lines of the own-image frames.

In the case where such wider image is unfavorable, deleting a portion of the two continuous own-images on the facing sides thereof by the width of the heavy lines will allow displaying the image across the two own-images properly.

The image processing unit may obtain, from the image codec apparatus at the site of the counterparts, information on a shape, a color, a size, and the like of the monitors of the image codec apparatus to generate an own-image frame having a shape, a color, a size, and the like that correspond to what the information indicates.

### Second Embodiment

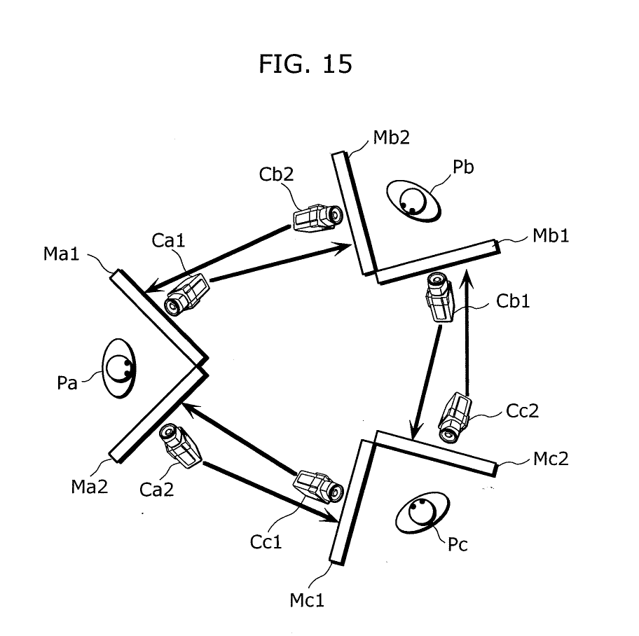

FIG. 15 is a schematic drawing of a video conference system including, at each site, an image codec apparatus according to a second embodiment of the present invention.

The video conference system includes three sites, and an image codec apparatus at each site has two cameras and two monitors.

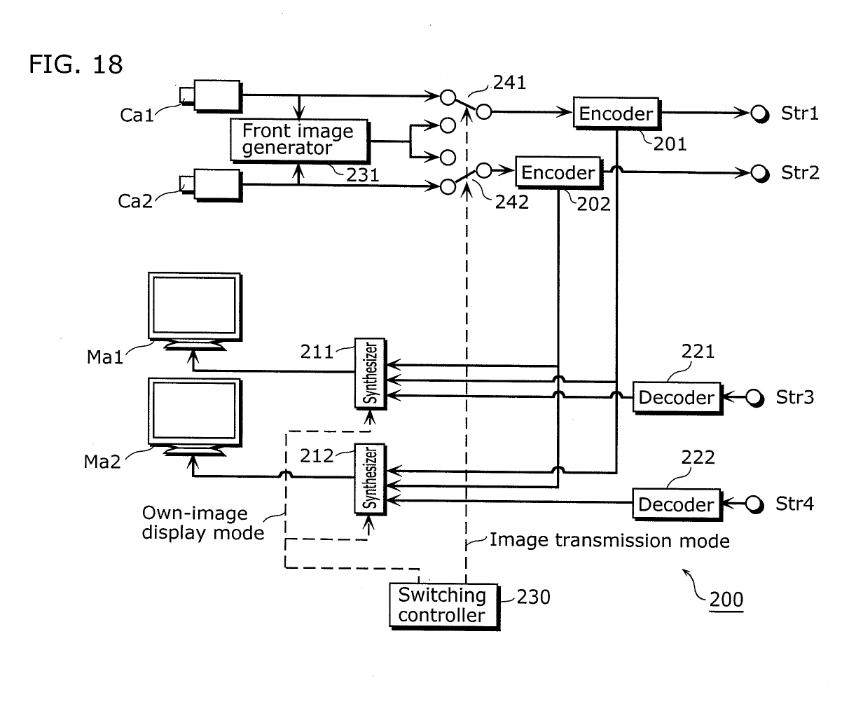

Specifically, the image codec apparatus at one site includes cameras Ca1 and Ca2 as shooting units, monitors Ma1 and Ma2 as image displaying units, encoders, decoders, synthesizers, and a front image generator (see FIG. 18). The image codec apparatus at another site includes cameras Cb1 and Cb2 as shooting units, monitors Mb1 and Mb2 as image displaying units, encoders, decoders, synthesizers, and a front image generator (see FIG. 18). The image codec apparatus at the other site includes cameras Cc1 and Cc2 as shooting units, monitors Mc1 and Mc2 as image displaying units, encoders, decoders, synthesizers, and a front image generator (see FIG. 18). The encoders, the decoders, the synthesizers, and the front image generators will be described later.

The monitors Ma1 and Ma2, and the cameras Ca1 and Ca2 are installed in front of a person Pa. The monitors Mb1 and Mb2, and the cameras Cb1 and Cb2 are installed in front of a person Pb. The monitors Mc1 and Mc2, and the cameras Cc1 and Cc2 are installed in front of a person Pc.

The camera Ca1 shoots the person Pa from his left front and outputs an image thereby obtained to the monitor Mb2. The camera Ca2 shoots the person Pa from his right front and outputs an image thereby obtained to the monitor Mc1. Similarly, the camera Cb1 shoots the person Pb from his left front and outputs the image thereby obtained to the monitor Mc2. The camera Cb2 shoots the person Pb from his right front and outputs an image thereby obtained to the monitor Ma1. The camera Cc1 shoots the person Pc from his left front and outputs an image thereby obtained to the monitor Ma2. The camera Cc2 shoots the person Pc from his right front and outputs an image thereby obtained to the monitor Mb1.

Specifically, the two respective cameras (for example, cameras Ca1, and Ca2) in the image codec apparatus (the system at each site) in the second embodiment, shoot in order to generate taken-image data that represents taken-images, and then output the taken-image data. The encoders code the taken-image data and transmit the taken-image data to the image codec apparatus at the other site. The decoders obtain, from the image codec apparatus at the other sites, coded image data that represent taken-images taken at the other sites, and decode the coded image data in order to generate decoded image data. The monitors (for example, the monitors Ma1 and Ma2) display decoded images that are represented by the decoded image data transmitted from the decoders.

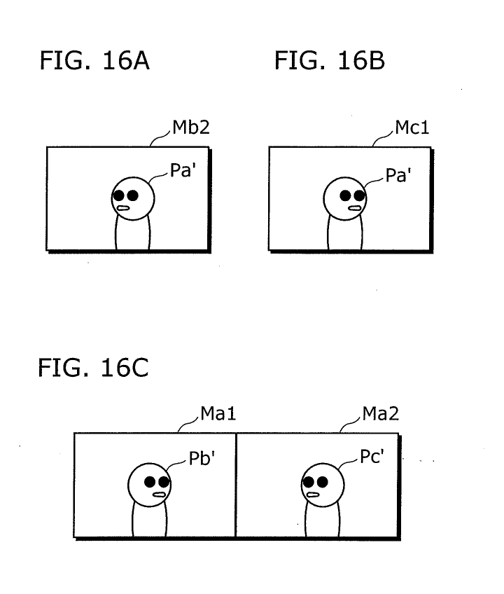

FIGS. 16A to 16C show images to be displayed on the monitors.

The monitor Mb2 displays, as shown in FIG. 16A, an image taken with the camera Ca1, in other words, an image Pa′ taken from the left of the person Pa. The monitor Mc1 displays, as shown in FIG. 16B, an image taken with the camera Ca1, in other words, an image Pa′ taken from the right of the person Pa. Similarly, the monitor Ma1 displays, as shown in FIG. 16C, an image taken with the camera Cb2, in other words, an image Pb′ taken from the right of the person Pb. The monitor Ma2 displays, as shown in FIG. 16C, an image taken with the camera Cc1, in other words, an image Pc′ taken from the left of the person Pc.

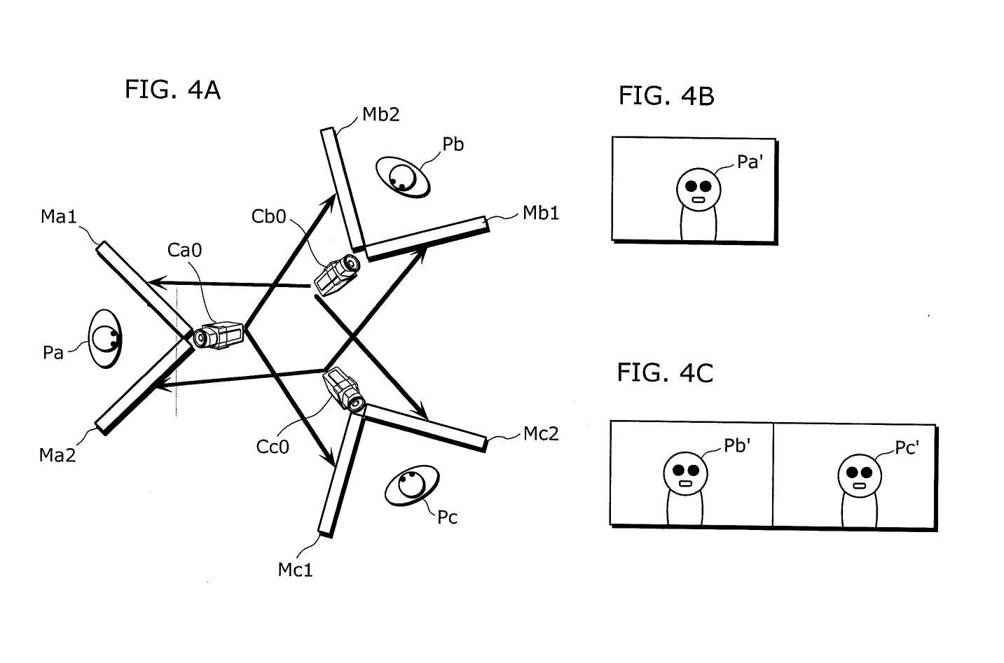

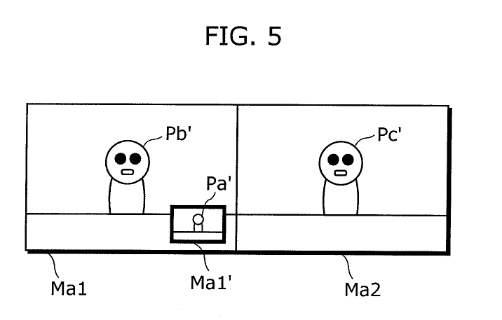

When viewing the monitors Ma1 and Ma2 from the person Pa, the person Pb looks as if he was facing toward the persons Pa and Pc, and the person Pc looks as if he was facing toward the persons Pa and Pb, as shown in FIG. 16C. Accordingly, compared to the case where the persons Pb and Pc look as if they were always looking only at the person Pa as shown in FIG. 4C, the second embodiment causes less discomfort when the persons Pb and Pc speak to each other. In other words, the second embodiment provides users with a stronger sense of presence than the video conference system that includes only a single camera for each site as shown in FIG. 4A does.

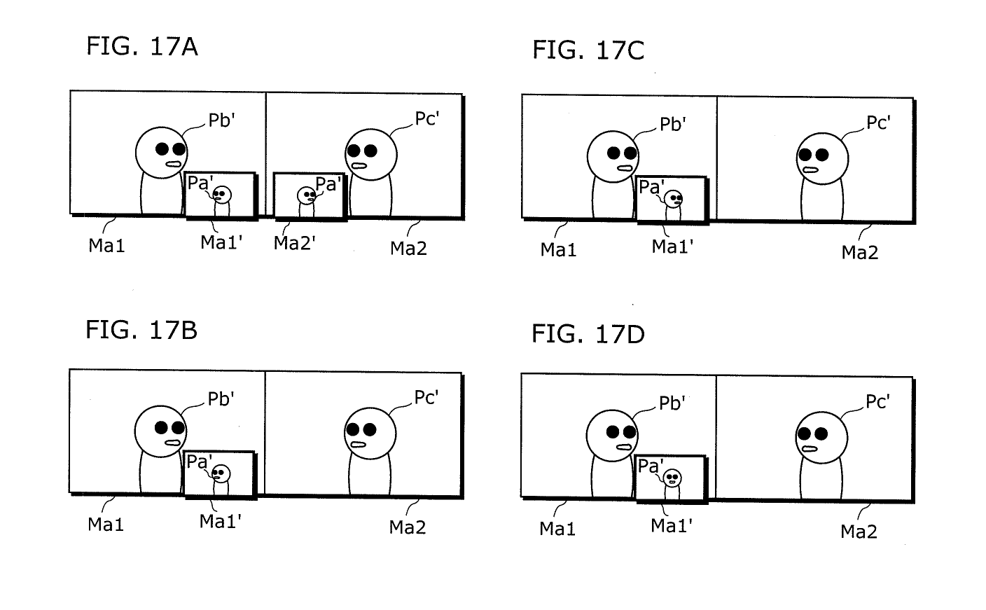

FIGS. 17A to 17D show examples of own-images to be displayed in the video conference system according to the second embodiment.

The monitor Ma1 displays, as shown in FIG. 17A, an own-image in an own-image frame Ma1′ while displaying an image Pb′ of the person Pb. The own-image includes an image Pa′ of the person Pa to be transmitted to the site of the person Pb. The monitor Ma2 displays, as shown in FIG. 17A, an own-image in an own-image frame Ma2′ while displaying an image Pb′ of the person Pb. The own-image includes an image Pa′ of the person Pa to be transmitted to the site of the person Pc.

Specifically, the monitor Ma1 displays, as an own-image, an image taken with the camera Ca1 at the site that the monitor Ma1 belongs to, as well as an image taken with the camera Cb1 at another site. Similarly, the monitor Ma2 displays, as an own-image, an image taken with the camera Ca1 at the site that the monitor Ma2 belongs to, as well as an image taken with the camera Cc1 at the other site.

Shooting the person Pa with two cameras and displaying the two own-images of the person Pa as described above will allow the person Pa to intuitively grasp images transmitted to his counterparts respectively. The own-images on the monitors Ma1 and Ma2 are preferably positioned nearer the border between these monitors. Thus, the images of the persons in these own-images can always face toward the images of the counterparts displayed on the monitors respectively. Specifically, the image Pb′ of the counterpart Pb and the image Pa′ of the person Pa in the own-image can face toward each other on the monitor Ma1, and the image Pc′ of the counterpart Pc and the image Pa′ of the person Pa in the own-image can face toward each other on the monitor Ma2. As a result, there is an advantage that a user can have a stronger feeling of having an interaction with his counterpart.

Optionally, display of an own-image on the monitor Ma2 may be disabled as shown in FIG. 17B. Further optionally, the image taken with the camera Ca2 may be displayed as an own-image not on the monitor Ma2, but in the own-image frame Ma1′ on the monitor Ma1 as shown in FIG. 17C.

Thus, an area for displaying the own-image on the monitor can be reduced so that an area for displaying the image obtained from the counterpart can be enlarged.

Optionally, a front image of the person Pa, in other words, an image as if taken from a direction from which neither the camera Ca1 nor Ca2 would take, may be generated and displayed as an own-image in the own-image frame Ma1′ as shown in FIG. 17D.

Generating an image of a person facing front (front image) requires advanced technologies and complicated processing. However, in the case where an image codec apparatus has a function of generating a front image and transmitting the front image to another site, the function is an effective technique for a user to check his transmitted image.

Thus, in displaying an own-image, the image codec apparatus in the video conference system according to the second embodiment selects a configuration in which the own-images are displayed as shown in FIGS. 17A to 17D.

Specifically, the image codec apparatus in the video conference system according to the second embodiment includes an image processing unit (not shown) for generating processed image data by executing image processing on taken-image data generated by the two cameras. The processed image data represents a processed image obtained as a result of adjusting a configuration in which two own-images are displayed. Examples of such processed image include the two own-image frames Ma1′ and Ma2′, and the images in these frames shown in FIG. 17A; the own-image frame Ma1′ and the image taken with the camera Ca1 and displayed in this frame shown in FIG. 17B; the own-image frame Ma1′ and the image taken with the camera Ca2 and displayed in this frame shown in FIG. 17C; and the own-image frame Ma1′ and the front image in this frame shown in FIG. 17D.

The image processing unit in the video conference system according to the second embodiment selects one of four image processing methods, and then, according to the selected image processing method, generates processed image data that represents a processed image as described above. The image codec apparatus in the video conference system according to the second embodiment has also an image synthesizing unit (see synthesizer in FIG. 18). The synthesizing unit synthesizes the processed image that is represented by the processed image data with a decoded image that has been originally taken at another site and is represented by the decoded image data. The image synthesizing unit outputs synthesized image data that represents a synthesized image. The monitors (for example, the monitors Ma1 and Ma2) obtain the synthesized image data as image display data, and then display, as shown in FIGS. 17A to 17D, images represented by the image display data.

Optionally, the displaying configurations shown in FIGS. 17A to 17D may be combined to produce a new configuration in which an own-image is displayed.

The image codec apparatus in the video conference system according to the first embodiment includes also a switching unit (switching controller in FIG. 18) that switches data to be obtained as image display data by monitors between the synthesized image data outputted from the image synthesizing unit and the decoded image data generated by the decoder. The switching unit switches between the data according to, for example, a user operation. Therefore, display of processed images on the two monitors switches between enabled and disabled states.

Further, the image processing unit selects one image processing method from the four image processing methods according to, for example: (i) an explicit instruction on selection by a user; (ii) a usage history and/or a preference of a user; (iii) the number of persons (one or plural) being shot with cameras; and (iv) presence or absence of a person shot with a plurality of cameras concurrently. In the case with (ii) above, for example, the image processing unit manages, as a history, image processing methods selected by each user, and automatically selects one of the image processing methods that has been selected by a user frequently. The image processing unit may select one of the image processing methods also according to a result of a combination of above-mentioned (i) to (iv).

Each site (image codec apparatus) in the second embodiment has two cameras and two monitors; having two or more cameras is sufficient. Optionally, having a single monitor is also sufficient, and a curved monitor is also applicable.

FIG. 18 is a block diagram showing an example of configuration of the image codec apparatus included in a site of the video conference system according to the second embodiment.

An image codec apparatus 200 in the video conference system generates a front image from taken-images taken with two cameras. The image codec apparatus 200 codes the taken-images or the front image and transmits the coded taken-images or the coded front image to the sites of the counterparts, while decoding the coded taken-images or the coded front image to display them as an own-image.

Specifically, the image codec apparatus 200 includes the cameras Ca1 and Ca2, the monitors Ma1 and Ma2, encoders 201 and 202, decoders 221 and 222, synthesizers 211 and 212, switching controller 230, and an front image generator 231.

The front image generator 231, using images taken with the cameras Ca1 and Ca2 (taken-image data), generates front image data that represents a front image, and then outputs the front image data.

The selector 241 selects data to be inputted into the encoder 201, according to information on an image transmission mode obtained from the switching controller 230, from the taken-image data outputted from the camera Ca1 and the front image data outputted from the front image generator 231.

The selector 242 selects data to be inputted into the encoder 202, according to information on an image transmission mode obtained from the switching controller 230, from the taken-image data outputted from the camera Ca2 and the front image data outputted from the front image generator 231.

The encoder 201 obtains the taken-image data that represents the taken-image taken with the camera Ca1 or the front image data that represents the front image generated by the front image generator 231, and then codes the obtained data. Subsequently, the encoder 201 transmits a bitstream generated by the coding as a stream Str1 to the site of the counterpart. The encoder 201 also decodes the stream Str1 to generate an own-image, and then outputs, to the synthesizers 211 and 212, the generated own-image, in other words, either of the taken-image data or front image data that has been once coded and then decoded respectively.

Similarly, the encoder 202 obtains the taken-image data that represents the taken-image taken with the camera Ca2 or the front image data that represents the front image generated by the front image generator 231, and then codes the obtained data. Subsequently, the encoder 202 transmits a bitstream generated by the coding as a stream Str2 to the site of the counterpart. The encoder 202 also decodes the stream Str2 to generate an own-image, and then outputs, to the synthesizers 211 and 212, the generated own-image, in other words, either of the taken-image data or the front image data that has been once coded and then decoded respectively.

Bitstreams generated by coding images taken at the sites of the counterparts are inputted into the image codec apparatus 200 as streams Str3 and Str4.

Specifically, the decoder 221 obtains coded image data as the stream Str3, decodes the stream Str3 to generate decoded image data, and then outputs the decoded image data to the synthesizer 211.

The synthesizer 211 obtains, from the switching controller 230, an own-image display mode that indicates whether or not the own-image (the processed image) is to be displayed, and which image processing method is to be applied to. Subsequently, the synthesizer 211 processes the two own-images (the taken-image data or the front image data) outputted from the encoders 201 and 202. Specifically, the synthesizer 211 selects one of the two own-images (the taken-image data or the front image data) according to the own-image display mode. The synthesizer 111 also synthesizes (superimposes) the processed own-image (the processed image) on a decoded image that is represented by the image data generated through the decoding by the decoder 221, and then outputs a synthesized image to the monitor Ma1.

When the selected own-image display mode indicates that the own-image (the processed image) is not to be displayed, the synthesizer 211 outputs decoded image data that has been obtained from the decoder 221, as image display data to the monitor Ma1 without processing the taken-image data or synthesizing the decoded image.

Specifically, the decoder 222 obtains coded image data as a stream Str4, decodes the stream Str4 to generate decoded image data, and then outputs the decoded image data to the synthesizer 212.

The synthesizer 212 obtains, from the switching controller 230, an own-image display mode that indicates whether or not the own-image (the processed image) is to be displayed, and which image processing method is to be applied to. Subsequently, the synthesizer 212 processes the two own-images (the taken-image data or the front image data) outputted from the encoders 201 and 202. Specifically, the synthesizer 212 selects one of the two own-images (the taken-image data or the front image data) according to the own-image display mode. The synthesizer 212 also synthesizes (superimposes) the processed own-image (processed image) on a decoded image that is represented by the image data generated through the decoding by the decoder 222, and then outputs a synthesized image to the monitor Mat.

The switching controller 230 judges whether or not the own-image (the processed image) is displayed according to, for example, a user operation that the switching controller 230 has received. The switching controller 230 also selects, using a usage history, a preference of a user, and the like described above, one image processing method from the image processing methods shown in FIGS. 17A to 17D. Then, the switching controller 230 therefore transmits, to the synthesizers 211 and 212, an own-image display mode that indicates whether or not an own-image is to be displayed and which image processing method has been selected.

The switching controller 230 judges also which of the taken-image data taken by the camera Ca1 or the front image data is to be coded and transmitted to the other site and which of the taken-image data taken by the camera Ca2 or the front image data is to be coded and transmitted to the other site, according to, for example, a user operation that the switching controller 230 has received. Then, the switching controller 230 transmits, to the selectors 241 and 242, an image transmission mode that indicates a result of the judgment.

Thus, the second embodiment, as in the first embodiment, processes own-images of users, in other words, taken-images taken with a plurality of cameras, and then displays the own-images on monitors as processed images; therefore the users can shot with the cameras can check their own-images more properly.

The second embodiment describes displaying an image generated by coding and decoding a front image or a taken-image taken with a camera as an own-image. Optionally, either of the front image or the taken-image taken with the camera may be displayed as an own-image without being coded or decoded, as described in the first variation of the first embodiment.

### Third Embodiment

Further, a program recorded on a data storage medium such as a flexible disk for realizing the image codec apparatus described in either of the first or the second embodiment enables easy execution of the processing described in these embodiments in an independent computer system.

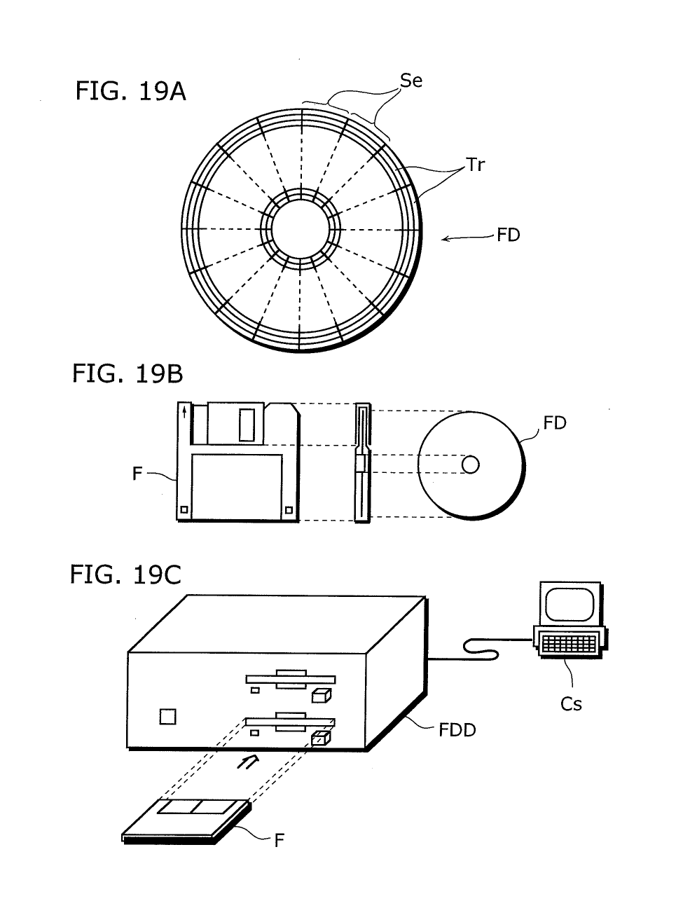

FIGS. 19A to 19C show a case where either of the image codec apparatus in the above-mentioned embodiments is to be realized on a computer system using a program recorded on a data storage medium such as a flexible disk.

FIG. 19B shows a front view and a cross-sectional view of the flexible disk, and a flexible disk body. FIG. 19A shows an example of a physical format of the flexible disk body as a storage medium body. The flexible disk body FD included in a case F has a surface where a plurality of tracks Tr are formed concentrically from the outermost circumference toward the innermost circumference.

Each track is divided into 16 sectors Se in an angular direction. In the flexible disk storing the above-mentioned program, the program is recorded in the sectors assigned on the flexible disk body FD.

FIG. 19C shows a configuration for recording and reproducing the above-mentioned program on the flexible disk body FD. When recording the above-mentioned program that realizes the image codec apparatus on the flexible disk body FD, the program is written from a computer system Cs on the flexible disk body FD via a flexible disk drive. When constructing the above-mentioned image codec apparatus in the computer system using the program on the flexible disk, the program is read using the flexible disk drive and transferred to the computer system.

A flexible disk is employed as the data storage medium in the above description; an optical disk may be employed instead as the data storage medium in the same manner as described for the flexible disk. Further, the data storage medium is not limited to the flexible disk or the optical disk. As long as the program can be stored, any medium, such as an integrated circuit (IC) card and a read-only-memory (ROM) cassette, may be employed instead also in the same manner as described for the flexible disk.

The functional blocks except cameras and monitors in the block diagrams (FIGS. 10A, 10B, 12, and 18) are typically realized as large scale integrations (LSIs), which are integrated circuits. These functional blocks may be integrated into a separate single chip, or some or all of the functional blocks may be integrated into a single chip. For example, all the functional blocks other than a memory block may be integrated into a single chip. Here an integrated circuit is referred to as an LSI; the integration circuit may be referred to as an IC, a system LSI, a super LSI or a ultra LSI, depending on the degree of integration.

The method for forming integrated circuitry is not limited to use of such LSIs. Dedicated circuitry or a general-purpose processor may be used instead of such LSIs for realizing the functional blocks. Also applicable are a field programmable gate array (FPGA), which allows post-manufacture programming, and a reconfigurable processor LSI, which allows post-manufacture reconfiguration of connection and setting of circuit cells therein.

Further, in the event that an advance in or derivation from semiconductor technology brings about an integrated circuitry technology whereby an LSI is replaced, the function blocks may be obviously integrated using such new technology. The adaptation of biotechnology or the like is possible.

Among the functional blocks, only a unit for storing data to be coded or decoded may be excluded from integration into a single chip and configured otherwise.

### INDUSTRIAL APPLICABILITY

The image codec apparatus according to the present invention can display own-images easily viewable for users of, for example, a video conference system with a plurality of cameras, and has a great deal of potential in industry for applicability to a video conference system and the like with a plurality of cameras.

1-18. (canceled)

19. An image codec apparatus comprising:
a decoding unit configured to receive a stream that includes coded image data and to decode the coded image data so as to generate decoded image data;
a plurality of shooting units configured to generate sets of taken-image data that represent taken-images having adjoining taken-image areas;
a coding unit configured to code the sets of taken-image data generated by said plurality of shooting units and to transmit streams that include the coded sets of taken-image data;
an image displaying unit configured to obtain image display data that represents an image and to display the image represented by the image display data on a plurality of adjoining monitors;
an image processing unit configured to generate processed image data by executing image processing for adjoining the sets of taken-image data; and
an image synthesizing unit configured to synthesize a processed image represented by the processed image data with a decoded image represented by the decoded image data which corresponds to predetermined ones of the monitors of said image displaying unit, and to output, as the image display data, synthesized image data that represents a synthesized image.

20. The image codec apparatus according to claim 19,
wherein said image processing unit is configured to execute image processing for adjoining the sets of taken-image data according to a configuration in which the sets of taken-image data are displayed on a plurality of adjoining monitors at a site that receives the streams transmitted from said coding unit.

21. The image codec apparatus according to claim 19,
wherein said image processing unit is configured to obtain a configuration in which the sets of taken-image data are displayed on the plurality of adjoining monitors at the site that receives the streams transmitted from said coding unit, and to execute the image processing for adjoining the sets of taken-image data according to the obtained configuration.

22. The image codec apparatus according to claim 19,
wherein said image processing unit is configured to generate, in the case where the sets of taken-image data are adjoined so that the processed image has a same appearance as an appearance of the adjoining plurality of monitors, the processed image data that provides a frame with each of the sets of taken-image data corresponding to each of the monitors of said image displaying unit.

23. An image codec method comprising:
receiving a stream that includes coded image data and decoding the coded image data for generating decoded image data;
generating sets of taken-image data that represent taken-images having adjoining taken-image areas;
coding the sets of taken-image data generated in said generating and transmitting streams that includes the coded sets of taken-image data;
obtaining image display data that represents an image and displaying the image represented by the image display data on a plurality of adjoining monitors;
generating processed image data by executing image processing for adjoining the sets of taken-image data; and
synthesizing a processed image represented by the processed image data with a decoded image represented by the decoded image data which corresponds to predetermined ones of the monitors used for said displaying, and outputting, as the image display data, synthesized image data that represents a synthesized image.

24. A program for an image codec apparatus, said program causing a computer to execute:
receiving a stream that includes coded image data and decoding the coded image data so as to generate decoded image data;
generating sets of taken-image data that represent taken-images having adjoining taken-image areas;
coding the sets of taken-image data generated in said generating and transmitting streams that includes the coded sets of taken-image data;
obtaining image display data that represents an image and displaying the image represented by the image display data on a plurality of adjoining monitors;
generating processed image data by executing image processing for adjoining the sets of taken-image data; and
synthesizing a processed image represented by the processed image data with decoded images represented by the sets of decoded image data each of which corresponds to predetermined ones of the monitors used for said displaying, and outputting, as the image display data, synthesized image data that represents a synthesized image.

25. An integrated circuit comprising:
a decoding unit configured to receive a stream that includes coded image data and to decode the coded image data so as to generate decoded image data;
a plurality of shooting units configured to generate sets of taken-image data that represent taken-images having adjoining taken-image areas;
a coding unit configured to code the sets of taken-image data generated by said plurality of shooting units and to transmit streams that include the coded sets of taken-image data;
an image displaying unit configured to obtain image display data that represents an image and to display the image represented by the image display data on a plurality of adjoining monitors;
an image processing unit configured to generate processed image data by executing image processing for adjoining the sets of taken-image data; and
an image synthesizing unit configured to synthesize a processed image represented by the processed image data with decoded images represented by the sets of decoded image data each of which corresponding to predetermined ones of the monitors of said image displaying unit, and to output, as the image display data, synthesized image data that represents a synthesized image.
